(19) United States
(12) Patent Application Publication
(10) Pub. No.: US 2019/0163518 A1
(43) Pub. Date: May 30, 2019

(54) INFORMATION PROCESSING SYSTEM, INFORMATION PROCESSING METHOD, AND SERVER

(71) Applicant: Preferred Networks, Inc., Tokyo (JP)

(72) Inventors: Tobias Pfeiffer, Tokyo (JP); Kunihiko Miyoshi, Tokyo (JP)

(21) Appl. No.: 16/203,383

(22) Filed: Nov. 28, 2018

(30) Foreign Application Priority Data
Nov. 29, 2017 (JP) 2017-229155

(51) Int. Cl. G06F 9/455; G06F 9/30

(52) U.S. Cl. CPC G06F 9/45558; G06F 2009/4557; G06F 2009/45562; G06F 9/3004

(57) ABSTRACT

An information processing system with memory and processing circuitry to build a virtualized image file from a base image file used as a base for an image file to be virtualized. Based on a description in a building instruction setting file, it associates the virtualized image file having been built with the base image file and the building instruction setting file, and stores the virtualized image file in the memory. It determines a combination of the base image file and the building instruction setting file with another combination of the base image file and the building instruction setting file to determine whether both combinations match, and when determining that both combinations match, it reuses the virtualized image file.

### CROSS REFERENCE TO RELATED APPLICATIONS

This application is based upon and claims the benefit of priority from the prior Japanese Patent Application No. 2017-229155, filed on Nov. 29, 2017, the entire contents of which are incorporated herein by reference.

### FIELD

The embodiments of the present invention relate to an information processing system, information processing method, and non-transitory computer readable medium.

### BACKGROUND

When a supercomputer or the like is used as a server, a file created by bundling executable binary files or script files describing execution procedures is sent to the server that executes the file. The server then loads the file to build an image file, thereby executing an intended process. This is a widespread practice. Not only the above case of sending a file to a server but also the case of applying a so-called container technique to execute computation or the like requires the above process of building an image file out of executable binary files or script files and the like that describe execution procedures. To build an image file, a base image file is used as the base of image file building. Procedures written in a building instruction setting file describing means for building the base image file are then followed to build the image file.

However, when the built image file is reused, the image file exactly the same as the original built image file or a hash value obtained at image file building is needed. In past cases, for example, if base image files are identical with each other but the contents of building instruction setting files are different from each other, the same image file is not built. In such a case, the image file needs to be rebuilt from scratch. Considering a method of calculating hash values, one can understand that a difference in the contents of the building instruction setting files results in a difference in hash values.

Building such an image file involves calculation loads and consumption of a storage capacity. In a high performance computing (HPC) environment or the like in which a number of users desire to share resources on the same computer, the users have to share a built image file or a hash value because the above image file building procedure requires to do so. This resource sharing is cumbersome and difficult to manage. Specifically, when two different binary files that should be executed in the same environment are present, a building instruction setting file includes a description of execution of the two binary files, and therefore, to perform computation in the same environment, an image file needs to be rebuilt. Thus, sharing the same environment or the like takes high computer-related costs or cumbersome management.

### BRIEF DESCRIPTION OF THE DRAWINGS

FIG. 1 is a block diagram of functional units of an information processing system according to one embodiment;

FIG. 2 is a flowchart of a virtualized image building process carried out by the information processing system according to one embodiment;

FIG. 3 is a flowchart of a virtualized image reusing process carried out by the information processing system according to one embodiment;

FIG. 4 depicts an example of a building instruction setting file according to one embodiment;

FIG. 5 is a block diagram of another example of the function of the information processing system according to one embodiment.

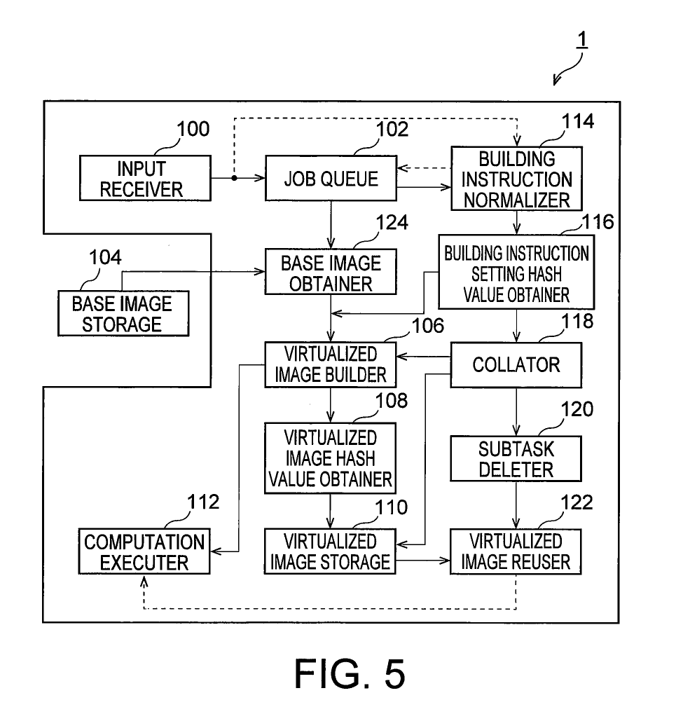

### DETAILED DESCRIPTION

According to one embodiment, an information processing system includes a memory and processing circuitry connected with the memory configured to build a virtualized image file (a virtual disk image, or a virtual image file) from a base image file used as a base for an image file to be virtualized, based on a description included in a building instruction setting file, associate the virtualized image file having been built with the base image file and the building instruction setting file and store the virtualized image file in the memory, determine a combination of the base image file and the building instruction setting file, the combination being input, with another combination of the base image file and the building instruction setting file, the combination being stored in the memory, to determine whether both combinations match, and when determining that both combinations match, reuse the virtualized image file, based on information on the virtualized image file associated with the combination of the base image file and building instruction setting file, wherein information processing is carried out in a virtualized environment, based on the image file. Embodiments will now be explained with reference to the accompanying drawings. The present invention is not limited to the embodiments.

### Configuration

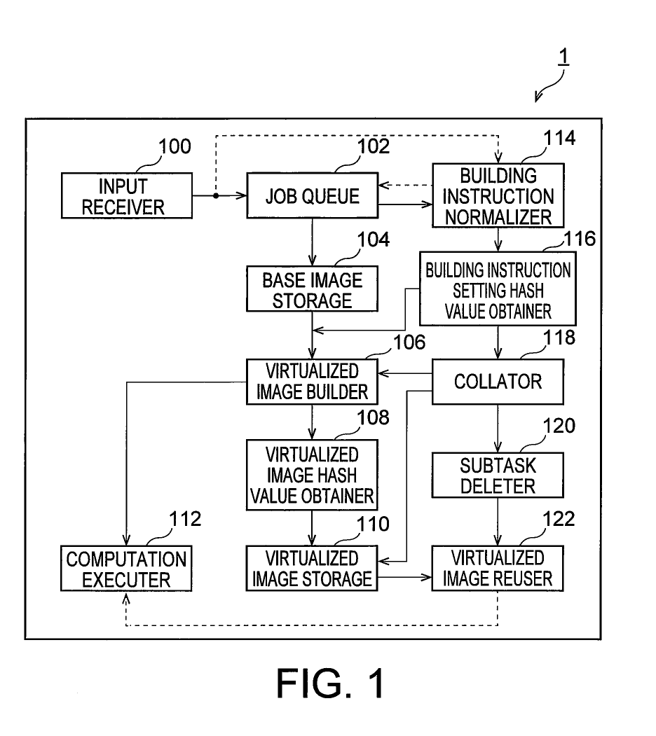

FIG. 1 is a block diagram of functional units of an information processing system 1 according to one embodiment. The information processing system 1 includes an input receiver 100, a job queue 102, a base image storage 104, a virtualized image builder 106, a virtualized image hash value obtainer 108, a virtualized image storage 110, a computation executer 112, a building instruction normalizer 114, a building instruction setting hash value obtainer 116, a determiner 118, a subtask deleter 120, and a virtualized image reuser 122. In the following descriptions, the term “virtualized image” may be rewritten in “virtual disk image file” or “virtual image file.”

The information processing system 1 is a system that builds a virtualized environment (virtualized image) from input information of a base image file and input information of a building instruction setting file and that performs specified computation in the virtualized image to output a computation result.

According to this embodiment, the information processing system 1 builds a virtualized image file from a base image file according to procedures described in a building instruction setting file, thereby builds a virtualized environment (hereinafter, “virtual environment”). The building instruction setting file may include also a description of computation that is to be executed in a virtualized image after building the virtualized image.

The building instruction setting file includes descriptions of, for example, a building instruction including a setting file for an operating system (OS), an instruction on environment settings to be made in the OS after building of the OS, an instruction for the OS with a set environment to obtain necessary files, and computation that the OS performs using the files.

The setting file for the OS is a file that describes settings necessary for installing the OS, such as file format setting, physical memory volume, and partition setting including swap area setting. The instruction on environment settings in the OS is an instruction on settings necessary for computation, such as network setting, setting of a library used for computation, and setting of paths for performing computation.

The instruction to obtain necessary files is an instruction to obtain data and the like used for computation. When the system performs machine learning in a virtual environment, for example, training data for the machine learning is input data and the like. Such data does not need to be actually downloaded according to the instruction but may be downloaded when the machine learning is performed.

Computation in the above case refers to a program for the system to perform the machine learning. This program may be a program by which a binary file compiled in advance is copied to the virtual environment, based on the building instruction setting file, or a program by which a source file is copied to the virtual environment in which a binary file is compiled from the source file.

Information of the base image file may be input as separate information to information of the building instruction setting file or may be information described in the building instruction setting file. When the information of the base image file is described in the building instruction setting file, for example, the information may almost uniquely determine a file used as the base image file, based on a hash value or the like.

A configuration of the information processing system 1 will be described.

The input receiver 100 is an interface that serves also as a connection to external equipment, and receives incoming data from external equipment. For example, the input receiver 100 receives a specified base image file, a building instruction setting file, and other necessary files or the like.

The job queue 102 is a so-called job queue. The job queue 102 stores jobs described in a building instruction setting file in the form of a job queue and carries out processes according to a first-in/first-out (FIFO) rule. A job described in the building instruction setting file may be divided into a plurality of subtasks. In such a case, these subtasks are each stored in the job queue 102 and are executed in sequence. The job queue 102 may process jobs according to a rule different from the FIFO rule, such as a first in/last out (FILO) rule.

The base image storage 104 is a database that stores various base images. Base images may be stored such that the base images are associated respectively with hash values for the base images. Such a base image is, for example, an image file for an OS, and is stored for the type of each OS and for each revised version (version number) of the OS. A hash value is thus associated with each of such image files and is stored. When the information processing system 1 is compatible with both 32-bit central processing unit (CPU) and 64-bit central processing unit (CPU) (including a case where the system 1 is capable of emulating both CPUs), OSs that run respectively on these CPUs with different working bits may be stored.

Based on an input building instruction setting file received by the input receiver 100, the virtualized image builder 106 builds a virtualized image from a base image file stored in the base image storage 104.

The virtualized image hash value obtainer 108 obtains a hash value for a virtualized image built by the virtualized image builder 106. As it will be described later, when information associating different files with each other in the virtualized image storage 110 is information different from a hash value, such as a file name, a file size, and a timestamp (updating date, creation date, or the like), the virtualized image hash value obtainer 108 works as a virtualized image information obtainer that obtains not only the hash value but also each piece of the above information.

The virtualized image storage 110 associates a virtualized image file built by the virtualized image builder 106 and a hash value for the virtualized image file obtained by the virtualized image hash value obtainer 108 with a hash value for a base image file received by the input receiver 100 and with a hash value for a building instruction setting file, and stores the associated virtualized image file and hash values. The above stored information is not limited to hash values but may be other kind of information if such information almost uniquely determines a file in a proper manner. For example, when strict file naming rules are set so that a file name is determined uniquely by the file contents, such a file name may be used as information that substitutes for a hash value. Furthermore, a file size, an updating date, a creation date, or the like may also be used as information that substitutes for a hash value.

The computation executer 112 executes computation or the like in a built virtual environment. In a built virtual environment, the computation executer, for example, obtains or creates a binary file or the like described in a building instruction setting file and executes a process described in the building instruction setting file.

The building instruction normalizer 114 normalizes a description included in a building instruction setting file, according to given rules, to correct discrepancies in description of the contents of the building instruction setting file. The building instruction normalizer 114 may be provided as a so-called preprocessor. For example, when “1” and “TRUE” represent the same state as Boolean variables, the building instruction normalizer 114 rewrites every “TRUE” included in a building instruction setting file to “1”, thereby revises the contents of the building instruction setting file in which “1” and “TRUE” are present together as different expressions into correct contents in which the same expression “1” is adopted.

Other operations the building instruction normalizer 114 may carry out include deletion of a comment, an unnecessary line break, or space and switching of the order of variable definitions. Because the determiner 118, which will be described later, compares hash values for a building instruction setting file to determine whether the hash values match, the building instruction normalizer 114 maintains the same descriptive contents of the building instruction setting file when the same process is carried out.

The building instruction setting hash value obtainer 116 obtains a hash value for a normalized building instruction setting file. When a plurality of subtasks are described in a building instruction setting file, the building instruction setting hash value obtainer 116 may obtain a hash value for a part of the building instruction setting file that includes a description of the head of the file up to a description of each of the subtasks. Specifically, for example, when a job described in the building instruction setting file is made up of a subtask 1, a subtask 2, and a subtask 3 that are to be executed in increasing order, the building instruction setting hash value obtainer 116 obtains a hash value for a description of the subtask 1, a hash value for a description of the subtask 1 and the subtask 2, and a hash value for a description of the subtask 1, subtask 2, and subtask 3.

As in the case of information on a virtualized image file stored in the virtualized image storage 110, a file name, a file size, an updating date, a creation date, or the like may be used in place of a hash value, as information on a building instruction setting file. Furthermore, these pieces of information may be combined and associated with each other. In such a case, information on the virtualized image file and information on the building instruction setting file may be different in type from each other. For example, the information on the virtualized image file may be a hash value while the information on the building instruction setting file may be a creation date. Hereinafter, a part written as hash value may be read as other types of information, such as a file name and a file size. Similar to the case of the virtualized image hash value obtainer 108, when the building instruction setting hash value obtainer 116 obtains these other types of information, the building instruction setting hash value obtainer 116 works as a building instruction setting information obtainer that obtains such other types of information.

The determiner 118 determines whether a combination of a hash value for a base image file and a hash value for a building instruction setting file is stored in the virtualized image storage 110. The hash value for the building instruction setting file may be a hash value for a description that covers up to a subtask, the hash value being obtained by the building instruction setting hash value obtainer 116. In this case, a virtualized image built for the description covering up to the subtask is stored in the virtualized image storage 110.

When the determiner 118 determines that a combination of hash values that matches a combination of a hash value for a base image file and a hash value for a building instruction setting file describing up to a certain subtask is stored in the virtualized image storage 110, the subtask deleter 120 deletes a task including up to the subtask enqueued in the job queue 102. This task deletion is carried out by deleting information from the job queue 102 or not executing a process on the task including up to the subtask after dequeuing the task from the job queue 102.

When the determiner 118 finds a combination of hash values that matches the above combination of hash values, the virtualized image reuser 122 obtains a virtualized image associated with the combination of hash values from the virtualized image storage 110 and reuses the obtained virtualized image without rebuilding the virtualized image.

In the above configuration, when information on the base image file is described in the building instruction setting file, a part written as a hash value for the base image file and hash value for the building instruction setting file may be read as hash values for the building instruction setting file. This means that whether base image files match may be determined by comparing hash values for the building instruction setting file with each other.

### Operation

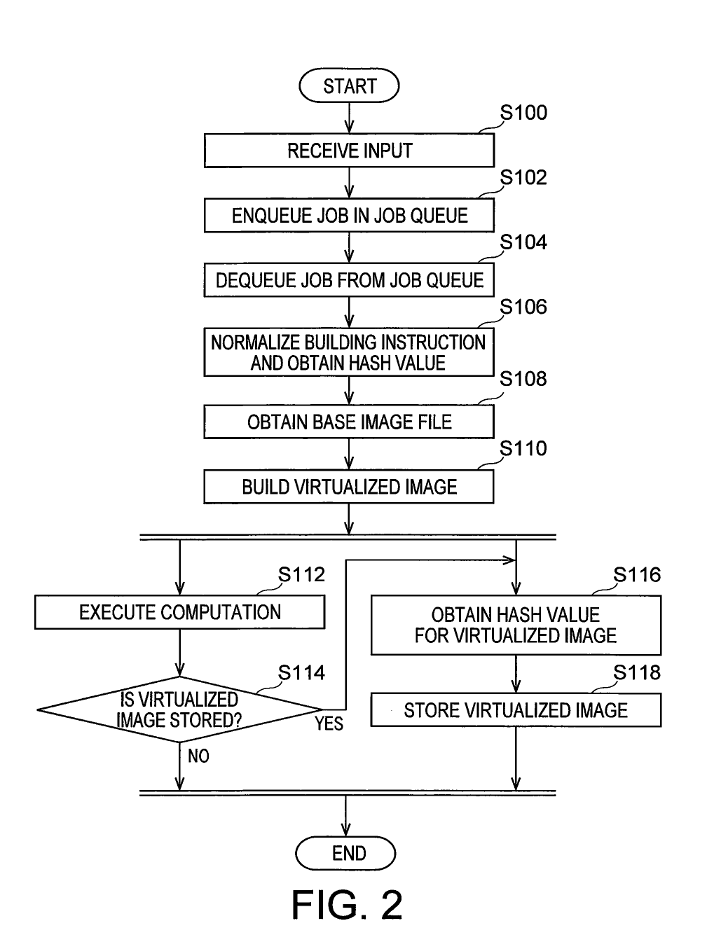

Processes carried out by the information processing system 1 will then be described. FIG. 2 is a flowchart showing the flow of processes of building a virtualized image from a base image file and a building instruction setting file, executing computation, and storing the virtualized image.

First, the information processing system 1 receives input of information on a base image file to be used and a building instruction setting file, via the input receiver 100 (step S100). As described above, information of the base image file is the base image file itself, a hash value for the base image file, or a name representing an OS, its revision number, or the like for the base image file. The information of the base image file may be described in the building instruction setting file.

Subsequently, a job described in the received building instruction setting file is enqueued in the job queue 102 (step S102). At this time, the job described in the received building instruction setting file may be enqueued as one job. When the job described in the building instruction setting file is made up of a plurality of subtasks, each of the subtasks may be enqueued as one job.

The job enqueued in the job queue 102 is then dequeued according to the FIFO rule and is executed (step S104). In a similar manner at the above enqueuing step, the job described in the building instruction setting file may be dequeued as one job or each of the subtasks may be dequeued as one job. The building instruction setting file subjected to the dequeuing process is normalized and a hash value for the normalized building instruction setting file is obtained (step S106). When each of the subtasks is dequeued, a hash value for a description covering the start of the building instruction up to the dequeued subtask is obtained.

These steps S104 and S106 may be executed in reverse order. This means that when these steps are executed in reverse order, the descriptive contents of the building instruction setting file is normalized first, and the hash value for the description covering up to the subtask is obtained, and then the job is dequeued. Furthermore, normalization of the building instruction setting file may be carried out before job enqueuing to the job queue 102. When normalization of the building instruction setting file is carried out before job enqueuing to the job queue 102, a data flow indicated by a broken line in FIG. 1 results. Specifically, the building instruction setting file received by the input receiver 100 is normalized by the building instruction normalizer 114 and then a job described in the building instruction setting file is enqueued in the job queue 102.

Subsequently, a base image file is obtained from the base image storage 104, based on the information of the base image file (step S108). When the input receiver 100 receives the base image file itself, the base image file may be used directly. In this case, a hash value for the received base image file is obtained, and when a base image file corresponding to the obtained hash value is not stored in the base image storage 104, the base image file may be associated with the hash value and stored in the base image storage 104.

Subsequently, based on a job dequeued from the job queue 102, the virtualized image builder 106 builds a virtualized image from the base image file (step S110). When a series of subtasks are enqueued in the job queue 102, the subtasks are each executed sequentially as a dequeued job.

Then, computation and an image file storage process are carried out simultaneously as parallel processing. These processes, however, do not actually need to be carried out simultaneously, and may be carried out such that one process is finished first and then the other process is carried out. FIG. 2 includes an arrow indicating transition from a branch on the left side to a branch on the right side. This does not always indicate transition of a step between a plurality of branched steps but, in FIG. 2, merely indicates that the same step is carried out at both branches. It may be possible, nevertheless, that a step of computation is ended and then a message or the like is sent to a step of storage process to execute the storage process.

As a step of computation, the computation executer 112 executes computation or the like in the virtualize image, based on a dequeued job (step S112). Through a series of these steps, a process including building the virtualized image from the base image file and executing computation in the virtualized image is executed.

Subsequently, whether or not to store the result of computation in the virtualized image storage 110 as a virtualized image is determined (step S114). This determination takes various patterns. For example, the user may determine in advance whether or not to store the result of computation as an image file or determine whether or not to store the result of computation during computation and transmit the result of computation to a server. The user may set a flag during computation and determine whether or not to store the virtualized image according to the flag. In another case, the user may determine that whatever data computed is all stored as the virtualized image.

When the result of computation is not stored as the virtualized image (step S114: No), the computation executer 112 may output the result of computation to a database or a client machine or the like located outside the virtualized image, based on a specified computation process. When the result of computation is stored as the virtualized image (step S114: Yes), the process flow proceeds to a step at which the result of computation is stored in the virtualized image storage 110 as the virtualized image.

In parallel with execution of computation or at a point in time before or after execution of computation, the virtualized image hash value obtainer 108 obtains a hash value for the built virtualized image (step S116).

Subsequently, the obtained hash value and the virtualized image are associated with the hash value for the base image file and with the hash value for the building instruction setting file and are stored in the virtualized image storage 110 (step S118). When the hash value for the base image file used is not obtained, the hash value may be obtained at a point in time of storing the virtualized image. Through a series of these steps, a process including building the virtualized image, executing computation, and storing the virtualized image is executed.

This process may be carried out in the form of various modifications. In one modification, for example, at a point in time at which a virtual environment has been built, a process including steps S116 and S118 is certainly carried out before execution of computation. In another modification, the process including steps S116 and S118 is not carried out before execution of computation but is carried out after execution of computation (step S112). In this manner, step S112 and the process including steps S116 and S118 are not always carried out simultaneously as parallel processing but may be carried out in an order properly specified by the user. Timing of storage of the virtualized image may be described in the building instruction setting file or may be set separately by the user.

When a job described in the building instruction setting file is made up of a plurality of subtasks and it is possible to carry out a process covering up to a certain subtask, suspend the process, and then resume the process to process a subtask following the certain subtask (so-called resume processing), a virtualized image and a hash value at a point at which the process covering up to the certain subtask is ended may be stored in the virtualized image storage 110. In this case, pieces of information to be associated are, for example, a combination of the hash value for the base image file and the hash value for the building instruction setting file describing the start of the process up to the point of end of the above certain subtask.

Storage of the virtualized image file at the point of end of a subtask may be carried out for each subtask. An example of the building instruction setting file used in this process is the same as the building instruction setting file mentioned in the above description of the configuration of the building instruction setting hash value obtainer 116. The virtualized image file to be stored is the virtualized image file built from the base image file according to the building instruction, as described above.

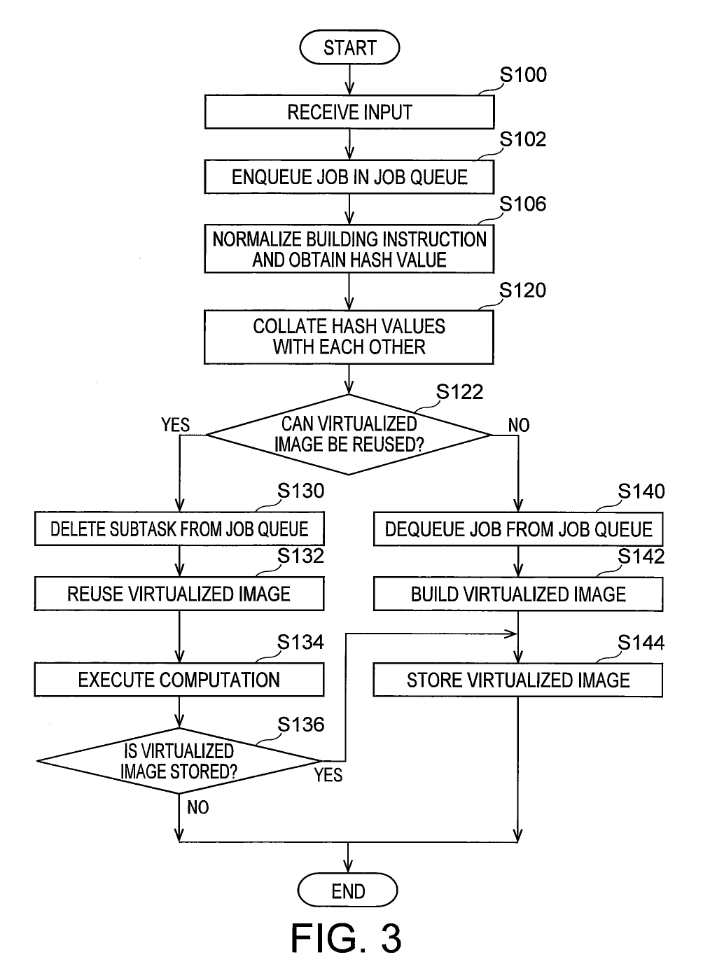

FIG. 3 is a flowchart of processes including a process that is carried out when a virtualized image is reused. Following the start of the processes, input is received (step S100), a job is enqueued in the job queue (step S102), and a building instruction is normalized and a hash value is obtained (step S106). As described above, step S106 may be executed before step S102.

Following step S106, the determiner 118 determines a combination of a hash value for a base image file to be used and a hash value for a building instruction setting file and compares it against combinations of hash values stored in the virtualized image storage 110 to determine whether a combination of hash values that matches the combination of the hash value for the base image file to be used and the hash value for the building instruction setting file is present (step S120). When the hash value for the base image file to be used is not obtained, the hash value may be obtained at this point.

Subsequently, based on the result of determination by the determiner 118, whether a virtualized image can be reused is determined (step S122). When the combination of hash values that matches is stored in the virtualized image storage 110 (step S122: Yes), a virtualized image is built from the same base image file according to the same building instruction, in which case the same virtualized image results. It is therefore determined that the virtualized image can be reused.

When a virtualized image can be reused, the subtask deleter 120 deletes subtasks up to the point of building the virtualized image to be reused, from the job enqueued in the job queue 102 (step S130).

Subsequently, a virtualized image stored in the virtualized image storage 110 is reused (step S132). Reuse of the virtualized image is executed by using a virtualized image file associated with the above combination of the hash value for the base image file and the hash value for the building instruction setting file, the virtualized image file being stored in the virtualized image storage 110.

Subsequently, the computation executer 112 executes computation (step S134). For example, when the entire building instruction setting file is reused, this computation is executed based on the reused virtualized image.

Subsequently, whether or not to store the virtualize image following the computation is determined (step S136). This process is the same as the process executed in step S114 of FIG. 2.

When some subtasks out of the entire subtasks described in the building instruction setting file are reused, the virtualized image to be reused is obtained from the virtualized image storage 110 and then subtasks following deleted subtasks, the subtasks being enqueued in the job queue 102, are dequeued in sequence. As a result, the computation executer 112 executes computation or the like in the virtualized image.

In this manner, for each subtask in the building instruction setting file, reuse of a virtualized image for a job up to the subtask is made possible so that the virtualized image is reused for the process as a whole. This is, however, not the only case. Effective reuse of a virtualized image is possible also in such a case where a building instruction includes a common instruction to some subtasks making up the entire job or a new building instruction using the result of an ended process is given to a subtask to follow the ended process.

When the virtualized image is reused, a new virtualized image may be stored in the virtualized image storage 110 at the end of the process through a process flow along a branch indicated as step S136: Yes. In this case, as the hash value for the building instruction setting file, a hash value for a description in the building instruction setting file that covers the start of the process up to the point of end of the subtask is associated and stored. By doing this, when a process to follow is to be further carried out or a result brought by the building instruction is to be used, a virtualized image in which computation is finished can be reused.

When the virtualized image cannot be reused (step S122: No), the job described in the building instruction setting file is dequeued to carry out processes of building a virtualized image (step S142) and storing the virtualized image (step S144). These processes are the same as the above processes executed in step S110, step S116, and S118.

In this manner, a virtualized image file to be reused may be identified based on a combination of a hash value for a base image file and a hash value for a building instruction setting file.

### (Building Instruction Setting File)

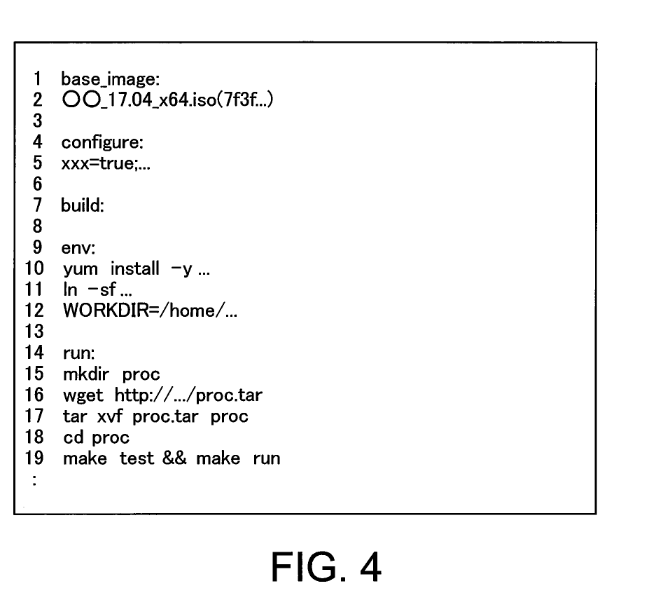

FIG. 4 depicts an example of a building instruction setting file. This example shows an approximate reproduction of the contents of a building instruction setting file and does not necessarily depict the contents in the actually used format of the file. Figures on the left side in the file of FIG. 4 represent line numbers. The first line to the end of the building instruction setting file describe a job indicating a series of processes. This job is enqueued in the job queue 102.

What is written in the first line indicates, for example, that the next line specifies a base image file. As shown in the second line, for example, the name of a base image file is written in the second line. In describing the base image file name, as shown in a parenthesis in the second line, a hash value may be written with other descriptions or the hash value only may be written.

What is written in the fourth line indicates, for example, that descriptions starting from the next line specify a configuration that is adopted when an OS is built from the base image file. This configuration is, for example, a configuration that can be specified when the OS is built from the base image file, such as network connection settings.

What is written in the seventh line represents, for example, a command to build the OS according to instructions on the base image file and configuration that are described on the lines above the seventh line. The presence of this seventh line leads to building of the OS.

What is written in the ninth line indicates, for example, that the next line and other lines to follow describe environment settings for the built OS. For example, the tenth line represents a command to install a necessary package or application software, and the eleventh line represents a static link to an installed executable file. The twelfth line represents environment variable setting. In another case, for example, this line describes execution of a process of installing a library and creating a path to the library.

What is written in the fourteenth line indicates, for example, that the next line and other lines to follow describe commands to be executed in a virtual environment. In this case, processes described in the fifteenth line and other lines to follow are executed in the virtual environment. As indicated in the sixteenth line, the processes may be executed such that a binary file to be processed is downloaded through a network or a file for performing computation is transmitted to the computation executer 112 in parallel with processing of the building instruction setting file.

The building instruction setting file is described in this manner.

Subtasks described above are created by, for example, dividing the job into a subtask equivalent to the first line to the second line, a subtask equivalent to the fourth line to the fifth line, a subtask equivalent to the seventh line, a subtask equivalent to the ninth line to twelfth line, and a subtask equivalent to the fourteenth line and other lines to follow. Computation may be further subdivided into more detailed subtasks by inserting a blank line in a series of lines following the fourteenth line and stating “run” again.

When the job is divided into these subtasks, if processing can be suspended for each of these subtasks, the virtualized image builder 106 may suspend the processing for each subtask. In such a case, the virtualized image hash value obtainer 108 obtains a hash value for a virtualized image for which the processing is suspended, and the virtualized image and the hash value are associated with a combination of the base image file and the building instruction setting file describing up to the point of suspension of the processing and are stored in the virtualized image storage 110.

For example, in the process including the first line to the seventh line representing OS building, a virtualized image is built and a hash value for the virtualized image is obtained, and then a hash value for a base image file and a hash value for a building instruction setting file equivalent to the descriptions made in the first to seventh lines in FIG. 4 are obtained and are stored in the virtualized image storage 110. As a result of this, when specified base image files as well as building settings are found the same, the virtualized image can be reused.

In another case, a virtualized image for subtasks following execution of the twelfth line representing environment building is obtained, or a virtualized image for subtasks covering up to the point of execution of a process of the nineteenth line is obtained.

When obtaining the hash value for the building instruction setting file, if changing the order of commands described in the building instruction setting file does not alter the processing, the building instruction setting hash value obtainer 116 may change the order of commands. For example, the twelfth line may be placed before the tenth line or eleventh line. In such a case, if those commands are a set of commands to execute the same process according to a preset rule, the order of the commands may be changed. In addition to the change of the order, if a command can be omitted, it may be omitted. In contrast, a command that should be included in the file in the first place but is obviously omitted may be added to the file and then the hash value may be obtained. In this manner, the building instruction setting file is normalized so that hash values for the case of the same process details match.

Patterns of division to subtasks are not limited to the above pattern. The granularity may be finer or rougher. For example, it may be possible that a command described in each line of FIG. 4 is enqueued in the job queue 102 as a subtask, and hash value obtainment, virtual image storage, or the like are carried out.

For example, it may be possible that after programs including up to the seventeenth line are decompressed, the hash value for the virtualized image is obtained and the virtualized image is stored. As a result of adopting this method, for example, when downloaded patch data is applied and then the processing is to be executed for another building instruction setting file starting from the eighteenth line, the virtualized image in which the processing up to the seventeenth line is finished can be reused.

In this manner, for each subtask, a hash value for a building instruction setting file describing up to the point of the subtask is obtained, is properly associated with the virtualized image, and is stored. This allows the granularity of reuse of the virtualized image to be finer.

It may also possible that descriptions covering up to the twelfth line are included in the building instruction setting file and descriptions of the fourteenth line and other lines to follow are separately compiled as a computation file. In this case, enqueuing in the job queue 102 as in the above case enables execution of the same operation as in the above case.

In an application example, an environment in which deep learning can be performed may be built. In this example, not a job concerning virtual environment building but a job concerning execution of the deep learning is described in the job queue 102. In this manner, enqueuing a job concerning learning in the job queue 102 enables quickly starting of machine learning by reusing the same environment.

This is effective, for example, for such a case that data given to a machine learning system is to be branched in the middle of an algorithm. In contrast, by storing an image including necessary big data obtained in the same environment, the image can be reused when the system is caused to perform separate learnings using the same big data.

As described above, according to this embodiment, in a case where a virtual environment is built and computation is executed, the reusability of the same virtual environment is improved without requiring management of image files, hash values, and the like by users or computers, such as image file sharing among users. This enables reuse of the virtual environment in a low-delay and low-load condition from which a process of rebuilding of the virtual environment is eliminated.

For example, when a large-scale cluster is run with a large volume of computations related to machine learning or the like, a virtualized image can be stored for each environment to be used. This case reduces an enormous time required for setting up the cluster. Further, by creating a virtualized image for each subtask, a cluster can be built in similar environments without requiring the user to know from which subtask the process flow branches and requiring computers to manage complicated hash values or the like. This reduces time consumption and computer-related costs.

Processing can be suspended for each subtask and at the point at which the subtask can be resumed, a virtualized image can be created and reused. For example, a certain library can be updated to a new version or the number of CPUs and graphical processing units (GPUs) to be used and memory capacities to be used can be set in the same environment. Furthermore, a file management system, such as Git, can be linked to management of individual files. Still in another case, making a virtual environment reusable in the above manner enables use of a machine learning model built by a different user at low cost.

It is not always necessary to store all virtualized images. A virtualized image may be stored for an environment that takes time to be built.

### Modifications

In the above embodiment, the base image storage 104 is included in the information processing system 1 but this is not the only possible case. Specifically, it may be possible that the base image storage 104 is outside the information processing system 1 and that a base image obtainer 124 obtains a specified base image file from the base image storage 104 through a network or the like.

According to this modification, the information processing system 1 becomes capable of obtaining external information. For example, this modification causes each OS to refer to and download information or the like in a specified repository. As a result, a more proper base image file can be obtained. In this modification, for example, a base image file for an OS used frequently, such as an image file for the latest stable version, may be cached in the information processing system 1.

The information processing system 1 according to the above embodiment may be built as a single server or may be built as a cluster including a plurality of computers. The information processing system 1 may be built in a cloud system connected to client machines via communication lines, such as the Internet.

It is unnecessary to package all of the above functional units in a server. For example, the building instruction normalizer 114, the building instruction setting hash value obtainer 116, and the like do not always need to be executed on a server. For example, when files of the same form can be created between users according to strict coding rules, building instruction normalization is not always necessary. Further, obtaining the hash value for the building instruction setting file may be carried out not by a server and a client machine included in the information processing system 1 but by a client machine outside the information processing system 1.

In the above embodiment, the hash values for the base image file, the building instruction setting file, and the virtualized image file are obtained. These hash values do not always need to be hash values of the same format. Hash values are applicable if they are obtained for individual files through the same procedure. When conflict of hash values occurs, for example, a conflicting hash value may be overwritten with new data or a method of obtaining hash values may be changed.

In the information processing system 1 according to the above embodiment, each functional unit may be a circuit including an analog circuit, digital circuit, or an analog/digital circuit. As a processor, processing circuitry or an electronic circuit including a controller and an arithmetic processing unit of a computer may be used. The information processing system 1 may include a control circuit that controls each of the functional units. These circuits may be packaged in the form of an application specific integrated circuit (ASIC) or field programmable gate array (FPGA).

In the above description, at least part of the information processing system 1 may be constructed as hardware or may be constructed as software which processes information to cause the CPU or the like to carry out operations. When part of the information processing system 1 is constructed as software, the information processing system 1 may store programs that realize at least part of the functions of the system in a recording medium, such as a flexible disc and a CD-ROM, and cause a computer to read and execute the programs. Such a recording medium is not limited to a removable recording medium, such as a magnetic disc and an optical disc, and may be a fixed recording medium, such as a hard disc device and a memory. In other words, the information processing system 1 may work such that information processing by software is executed as a specific operation using hardware resources. Furthermore, processing by software may be loaded onto a circuit, such as an FPGA, and executed by hardware. A job may be executed using, for example, an accelerator, such as a GPU.

For example, when a computer reads dedicated software out of a computer-readable recording medium, the computer can work as the system according to the above embodiment. The recording medium is not limited to a specific type. Further, when dedicated software downloaded through a communication network is installed in a computer, the computer can work as the system according to the above embodiment. In this manner, information processing by software is executed as a specific operation using hardware resources.

1. An information processing system comprising:
a memory; and
processing circuitry coupled to the memory and configured to:
build a virtualized image file from a base image file used as a base for an image file to be virtualized, based on a description included in a building instruction setting file;
associate the virtualized image file having been built with the base image file and the building instruction setting file and store the virtualized image file in the memory;
determine a combination of a base image file and a building instruction setting file, the combination being input, with another combination of the base image file and the building instruction setting file, the other combination being stored in the memory, to determine whether both combinations match; and
when determining that both combinations match, reuse the virtualized image file, based on information on the virtualized image file, wherein
information processing is carried out in a virtualized environment, based on the image file.

2. The information processing system according to claim 1,
wherein the processing circuitry obtains information on the virtualized image file, and wherein
the obtained virtualized image file, the base image file, and the building instruction setting file, each being stored in the memory, is associated with information on each of the files, respectively.

3. The information processing system according to claim 1,
wherein each of information on the virtualized image file, information on the base image file, and information on the building instruction setting file is at least one of information on a hash value, information on a time stamp, and information on a file size of each of the files, respectively.

4. The information processing system according to claim 1,
wherein the processing circuitry obtains information on the building instruction setting file.

5. The information processing system according to claim 1,
wherein in processing of subtasks making up a job described in the building instruction setting file, the processing circuitry associates the virtualized image file built up to a point of suspension of the processing with the base image file and with the building instruction setting file describing up to a certain subtask and stores the virtualized image file in the memory.

6. The information processing system according to claim 5, further comprising a job queue configured to:
include jobs enqueued in order of the subtasks described in the building instruction setting file; and
manage order of processing the enqueued jobs;
wherein when a combination of the base image file and the building instruction setting file describing up to one subtask out of the subtasks described therein is stored in the memory, the processing circuitry deletes, from the job queue, jobs including up to the subtask, and wherein
the processing circuitry reuses the virtualized image file based on the combination.

7. The information processing system according to claim 1,
wherein the processing circuitry normalizes a description in the building instruction setting file.

8. The information processing system according to claim 1,
wherein the processing circuitry associates the base image file with information on the base image file and stores the base image file in the memory.

9. The information processing system according to claim 1,
wherein the processing circuitry obtains a proper version of the base image file from a repository in which the base image file associated with information on the base image file is stored, based on the information on the base image file.

10. An information processing method comprising:
building, in processing circuitry, a virtualized image file from a base image file used as a base for an image file to be virtualized, based on a description included in a building instruction setting file;
associating the virtualized image file having been built with the base image file and the building instruction setting file and storing the virtualized image file in a memory;
determining a combination of a base image file and a building instruction setting file, the combination being input, with another combination of the base image file and the building instruction setting file, the other combination being stored in the memory, to determine whether both combinations match; and
when determining that both combinations match, reusing the virtualized image file, based on information on the virtualized image file.

11. The information processing method according to claim 10, further comprising:
obtaining information on the virtualized image file; and
storing, in the memory, the obtained virtualized image file, the base image file, and the building instruction setting file, associated with information on each of the files, respectively.

12. The information processing method according to claim 10,
wherein each of information on the virtualized image file, information on the base image file, and information on the building instruction setting file is at least one of information on a hash value, information on a time stamp, and information on a file size of each of the files, respectively.

13. The information processing method according to claim 10, further comprising:
obtaining information on the building instruction setting file.

14. The information processing method according to claim 10,
wherein associating, in processing of subtasks making up a job described in the building instruction setting file, the virtualized image file built up to a point of suspension of the processing with the base image file and with the building instruction setting file describing up to a certain subtask and stores the virtualized image file in the memory.

15. The information processing method according to claim 14, further comprising:
enqueueing, in a job queue, jobs in order of the subtasks described in the building instruction setting file;
managing, by the job queue, order of processing the enqueued jobs;
deleting, when a combination of the base image file and the building instruction setting file describing up to one subtask out of the subtasks described therein is stored in the memory, jobs including up to the subtask from the job queue; and
reusing the virtualized image file based on the combination.

16. The information processing method according to claim 10, further comprising:
normalizing a description in the building instruction setting file.

17. The information processing method according to claim 10, further comprising:
associating the base image file with information on the base image file and stores the base image file in the memory.

18. The information processing method according to claim 10, further comprising:
obtaining a proper version of the base image file from a repository in which the base image file associated with information on the base image file is stored, based on the information on the base image file.

19. A non-transitory computer readable medium storing therein a program which, when executed by a processor of a computer performs a method comprising:
building a virtualized image file from a base image file used as a base for an image file to be virtualized, based on a description included in a building instruction setting file;
associating the virtualized image file having been built with the base image file and the building instruction setting file and store the virtualized image file in a memory;
determining a combination of a base image file and a building instruction setting file, the combination being input, with another combination of the base image file and the building instruction setting file, the other combination being stored in the memory, to determine whether both combinations match; and
when determining that both combinations match, reusing the virtualized image file, based on information on the virtualized image file, wherein.

20. The non-transitory computer readable medium according to claim 19, wherein the method further comprises:
obtaining information on the virtualized image file; and
obtaining virtualized image file, the base image file, and the building instruction setting file, each being stored in the memory, is associated with information on each of the files, respectively.
